(19) United States
(12) Patent Application Publication
(10) Pub. No.: US 2024/0088510 A1
(43) Pub. Date: Mar. 14, 2024

(54) BATTERY PACK WITH INTERLEAVED CELLS

(71) Applicant: Our Next Energy, Inc., Novi, MI (US)

(72) Inventors: Steven Kaye, Oakland, CA (US); Cameron David Robertson, San Mateo, CA (US); Jason Davis, Livonia, MI (US); Mujeeb Ijaz, West Bloomfield, MI (US)

(21) Appl. No.: 18/464,800

(22) Filed: Sep. 11, 2023

Related U.S. Application Data
(60) Provisional application No. 63/375,243, filed on Sep. 11, 2022.

(51) Int. Cl. H01M 50/267; B60L 50/64; B60L 53/20; H01M 10/653; H01M 10/658; H01M 50/209; H01M 50/258; H01M 50/509

(52) U.S. Cl. CPC H01M 50/267; B60L 50/64; B60L 53/20; H01M 10/653; H01M 10/658; H01M 50/209; H01M 50/258; H01M 50/509; H02M 3/33584

(57) ABSTRACT

A battery pack that includes a cell array, a set of first cells of the cell array disposed within the battery pack as one or more first groups of electrically coupled cells, and a set of second cells of the cell array disposed within the module housing as one or more second groups of electrically coupled cells. The set of first cells have a first chemistry, the set of second cells have a second chemistry different from the first chemistry, and the set of first cells are interleaved with the set of second cells inside the battery pack.

### TECHNICAL FIELD

The present disclosure related generally to a modular battery pack. More specifically, the present disclosure relates to a battery pack with one or more cell arrays comprising interleaved cells.

### BACKGROUND

Batteries and other electrochemical energy storage devices have been in use for years and have been utilized in a wide range of application. A battery is a device that transforms chemical energy into electrical energy. The battery typically comprises one or more electrochemical cells, each with at least two electrodes that are electrically coupled in a specific order by an electrolyte substance, which can typically be either a solid or a liquid. A barrier that may be porous to the electrolyte substance may separate the electrodes from the electrolyte substance, preventing the electrodes from making contact with the electrolyte until desired. Batteries are normally designed to operate between, for example, 20 and 50 degrees Celsius in a normal operating range. However, in some cases, an electrochemical cell of the battery may experience a failure event which may cause the cell to overheat and catch fire, propagating the effect to other cells and the battery as a whole.

### BRIEF DESCRIPTION OF THE DRAWINGS

To easily identify the discussion of any particular element or act, the most significant digit or digits in a reference number refer to the figure number in which that element is first introduced.

FIG. 1 depicts a drivetrain and energy storage components in accordance with illustrative embodiments.

FIG. 2 depicts a diagram of a battery pack arrangement in accordance with an illustrative embodiment.

FIG. 3 depicts a perspective view of a battery pack comprising interleaved cells in accordance with an illustrative embodiment.

FIG. 4 depicts a top view of a battery pack in accordance with an illustrative embodiment.

FIG. 5 depicts an electrical schematic view of a battery pack in accordance with an illustrative embodiment.

FIG. 6 depicts a perspective view of a battery pack with a busbar arrangement in accordance with an illustrative embodiment.

FIG. 7A depicts a sketch of an interleaving pattern in accordance with an illustrative embodiment.

FIG. 7B depicts a sketch of an interleaving pattern in accordance with an illustrative embodiment.

FIG. 7C depicts a sketch of an interleaving pattern in accordance with an illustrative embodiment.

FIG. 7D depicts a sketch of an interleaving pattern in accordance with an illustrative embodiment.

FIG. 8A depicts a front view of a battery pack with a terminal and insulator arrangement in accordance with an illustrative embodiment.

FIG. 8B depicts a front view of a battery pack with a terminal and insulator arrangement in accordance with an illustrative embodiment.

FIG. 8C depicts a front view of a battery pack with a terminal and insulator arrangement in accordance with an illustrative embodiment.

FIG. 9A depicts a front view of a battery pack with a cell vent arrangement in accordance with an illustrative embodiment.

FIG. 9B depicts a cross-sectional view of a cell with a cell vent in accordance with an illustrative embodiment.

FIG. 10 depicts a method in accordance with an illustrative embodiment.

### DETAILED DESCRIPTION

The illustrative embodiments described herein are directed to battery pack having an enclosure that may house a plurality of interleaved cells. In an illustrative embodiment, the cells are interleaved to repress or prevent cell-to-cell propagation of thermal runway.

The illustrative embodiments recognize that heat generated in battery packs from a trigger cell under thermal runaway may be transferred to adjacent cells by convection of ejected hot matter and by direct conduction and radiative heat transfer, which may eventually lead to fires. The illustrative embodiments further recognize that thermal runaway can be very difficult to stop once it has started. It may be started when the temperature inside a cell reaches a point that causes a chemical reaction to occur inside the cells. This chemical reaction may produce even more heat, which drives the temperature higher, causing further chemical reactions that create more heat. In thermal runaway, the cell temperature may rise considerably fast, and energy stored in that cell may be released very suddenly. This chain reaction may create extremely high temperatures (around 400° C., or between 300° C. and 1200° C. or in some cases outside this range), causing gassing of the battery and a fire that may be inextinguishable.

One or more embodiments are directed to a battery pack that may comprise a cell array. The cell array may comprise a plurality of first cells disposed in the pack as one or more first groups of electrically coupled cells and a plurality of second disposed in the pack as one or more second groups of electrically coupled cells. Responsive to a request for energy transfer, the plurality of first cells may be electrically coupled in parallel to the plurality of second cells via a galvanically isolated bi-directional DC-DC converter. More specifically, the two sides of the DC-DC conversion system (with different chemistries on each side) may transfer electrical energy via a magnetic transformer coil with each block of cells sharing a common ground, but not otherwise electrically connected. The plurality of first cells may thus be in a parallel electrical coupling with the plurality of second cells during said energy transfer. The plurality of first cells may comprise a first chemistry and the plurality of second cells may comprise a second chemistry different from the first chemistry and the plurality of first cells may be interleaved with the plurality of second cells.

In an aspect herein, the battery pack may be composed of a number of individual modules grouped together to form the full battery pack. The individual modules may be further sealed or mechanically confined inside the battery pack, making it difficult to swap out. More modules mean more hardware for enclosing each additional module, connecting said each additional module electrically and connecting said each additional module to a thermal management system and/or battery management system which inevitable adds weight and volume to the battery pack. For example, high-voltage battery packs typically build groups of battery cells into modular building blocks or a plurality of cell modules that are individually installed into a larger pack enclosure. The cell modules may provide location and constraint to the component cells, protecting them from external shocks and vibrations and the outer pack enclosure may provide the final shape of the battery installed into an electric vehicle, providing restraint and protection to the modules as well as other control systems such as the battery management system, cooling system etc. The embodiments thus recognize a need to design the battery pack to eliminate excess volume and to locate, constrain, restrain, and structurally protect component cells by careful disposition of components. Though cell arrays may be disposed inside the modules, the cell arrays may alternatively be disposed directly inside the battery pack in a cell-to-pack configuration. In a cell-to-pack configuration, battery cells may be arranged directly inside sidewalls without the use of separate battery modules to house the cells.

In a further aspect, a busbar architecture, described hereinafter, may be utilized to dissipate heat more evenly to other cells during a thermal runway event of a first cell. A compliant insulator with low thermal conductivity may also be disposed between cells. The illustrative embodiments recognize that different busbar designs may be utilized, based on pack requirements, to electrically couple groups of cells together. By minimizing space occupied by busbars and providing a cross channel that may house electronics of cell modules, the volumetric energy density of the battery pack may be conserved or even increased.

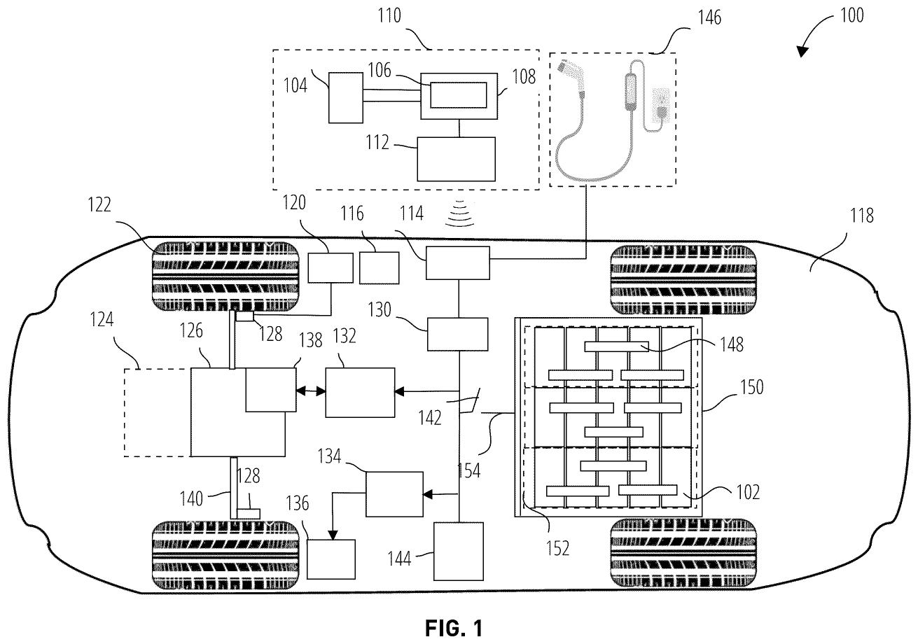

Turning to FIG. 1, a schematic of a generalized electric vehicle system 100 in which a busbar 148 of a battery pack 150 may be housed will be described. It will become apparent to a person skilled in the relevant art(s) that the concepts described herein are directed to all electrified/electric vehicles, including, but not limited to, battery electric vehicles (BEV's), plug-in hybrid electric vehicles, motor vehicles, railed vehicles, watercraft, and aircraft configured to utilize rechargeable electric batteries as their main source of energy to power their drive systems or that possess an all-electric drivetrain. Said busbars 148 may also be used in any other application in which a multi-chemistry battery pack is needed.

The electric vehicle 118 may comprise one or more electric machines 138 mechanically connected to a transmission 126. The electric machines 138 may be capable of operating as a motor or a generator. In addition, the transmission 126 may be mechanically connected to an engine 124, as in a plug-in hybrid electric vehicle (PHEV). The transmission 126 may also be mechanically connected to a drive shaft 140 that is mechanically connected to the wheels 120. The electric machines 138 can provide propulsion and deceleration capability when the engine 124 is turned on or off. The electric machines 138 also act as generators and can provide fuel economy benefits by recovering energy that would normally be lost as heat in the friction braking system. The electric machines 138 may also reduce vehicle emissions by allowing the engine 124 to operate at more efficient speeds and allowing the electric vehicle 118 to be operated in electric mode with the engine 124 off in the case of hybrid electric vehicles.

A battery pack 150 stores energy that can be used by the electric machines 138. The battery pack 150 typically provides a high voltage DC output and may be electrically connected to one or more power electronics modules 132. In some embodiments, the battery pack 150 comprises cells configured to have a high onset temperature for thermal runway, such as traction cells, as well as cells configured to have a comparatively lower onset temperature for thermal runway, such as a range extender cells. More specifically, the battery pack 150 may comprise cell arrays comprising cells configured to have a high onset temperature for thermal runway (such as, for example, some traction cells) interleaved with cells configured to have a comparatively lower onset temperature for thermal runway (such as, for example, some range extender cells) as described hereinafter. As used herein, “traction” cells may refer to cells used to provide motive power to a vehicle during routine, normal, and/or statistically-common operation. Conversely, “range extender” or “extender” cells may provide power to the vehicle when more power is required for operation, such as during a longer journey, when traveling up an incline for extended periods, or the like. Examples of traction and range-extender cells and associated battery systems are described in U.S. Patent Application Pub. No. 2022/0111759, the disclosure of which is incorporated by reference in its entirety. The two or more sets of cells disclosed herein may have a variety of different properties. For example, the cells may have different chemistries or other performance profile attributes, different physical dimensions, or the like. The performance profile may include, for example, onset temperature; heat release for thermal runaway; energy density; and resistance, such that the sets of cells differ in one or more of these properties. The two sets of cells may have the same chemistries or different chemistries, and any of the various performance profile attributes described herein may be the same or different between the two sets of cells.

For illustrative purposes, the cell arrays may be disposed in modules 152 in the battery pack, but this is not intended to be limiting. Cells 102 of the battery pack 150 may be electrically coupled by busbars 148. One or more contactors 142 may isolate the battery pack 150 from other components when opened and connect the battery pack 150 to other components when closed. To increase the energy densities available for electric vehicles, a structure of the busbars 148 is configured to eliminate unnecessary use of space as described hereinafter. The battery pack may also house other hardware such as, but not limited to the power electronics module 132, DC/DC converter module 134, system controller 116 (such as a battery management system (BMS)), power conversion module 130, battery thermal management system (cooling system and electric heaters) and contactors 142, though one or more of these may alternatively be outside the battery pack 150.

The power electronics module 132 may also be electrically connected to the electric machines 138 and may provide the ability to bi-directionally transfer energy between the battery pack 150 and the electric machines 138. For example, a traction cell may provide a DC voltage while the electric machines 138 may operate using a three-phase AC current. The power electronics module 132 may convert the DC voltage to a three-phase AC current for use by the electric machines 138. In a regenerative mode, the power electronics module 132 may convert the three-phase AC current from the electric machines 138 acting as generators to the DC voltage compatible with the battery pack 150. The description herein is equally applicable to a BEV. For a BEV, the transmission 126 may be a gear box connected to an electric machine 14 and the engine 124 may not be present.

In addition to providing energy for propulsion, the battery pack 150 may provide energy for other vehicle electrical systems. A typical system may include a DC/DC converter module 134 that converts the high voltage DC output of the battery pack 150 to a low voltage DC supply that is compatible with other vehicle loads. Other electrical loads 144, such as compressors and electric heaters, may be connected directly to the high-voltage without the use of a DC/DC converter module 134. The low-voltage systems may be electrically connected to an auxiliary battery 136 (e.g., 116V battery).

The battery pack 150 may be recharged by a charging system such as a wireless vehicle charging system 110 or a plug-in charging system 146. The wireless vehicle charging system 110 may include an external power source 104. The external power source 104 may be a connection to an electrical outlet. The external power source 104 may be electrically connected to electric vehicle supply equipment 108 (EVSE). The electric vehicle supply equipment 108 may provide an EVSE controller 106 to provide circuitry and controls to regulate and manage the transfer of energy between the external power source 104 and the electric vehicle 118. The external power source 104 may provide DC or AC electric power to the electric vehicle supply equipment 108. The electric vehicle supply equipment 108 may be coupled to a transmit coil 112 for wirelessly transferring energy to a receiver 114 of the vehicle 118 (which in the case of a wireless vehicle charging system 110 is a receive coil). The receiver 114 may be electrically connected to a charger or on-board power conversion module 136. The receiver 114 may be located on an underside of the electric vehicle 118. In the case of a plug-in charging system 146, the receiver 114 may be a plug-in receiver/charge port and may be configured to charge the battery pack 150 upon insertion of a plug-in charger. The power conversion module 130 may condition the power supplied to the receiver 114 to provide the proper voltage and current levels to the battery pack 150. The power conversion module 130 may interface with the electric vehicle supply equipment 108 to coordinate the delivery of power to the electric vehicle 118. The busbars 148 may provide the means to efficiently distribute power to the vehicles' various subsystems and not just the cells.

One or more wheel brakes 128 may be provided for decelerating the electric vehicle 118 and preventing motion of the electric vehicle 118. The wheel brakes 128 may be hydraulically actuated, electrically actuated, or some combination thereof. The wheel brakes 128 may be a part of a brake system 120. The brake system 120 may include other components to operate the wheel brakes 128. For simplicity, the figure depicts a single connection between the brake system 120 and one of the wheel brakes 128. A connection between the brake system 120 and the other wheel brakes 126 is implied. The brake system 120 may include a controller to monitor and coordinate the brake system 120. The brake system 120 may monitor the brake components and control the wheel brakes 128 for vehicle deceleration. The brake system 120 may respond to driver commands and may also operate autonomously to implement features such as stability control. The controller of the brake system 120 may implement a method of applying a requested brake force when requested by another controller or sub-function.

One or more electrical loads 144 may be electrically coupled to the high voltage (HV) bus 154 which may in turn be electrically coupled to the busbars 148. The electrical loads 144 may have an associated controller that operates and controls the electrical loads 144 when appropriate. Examples of electrical loads 144 may be a heating module or an air-conditioning module.

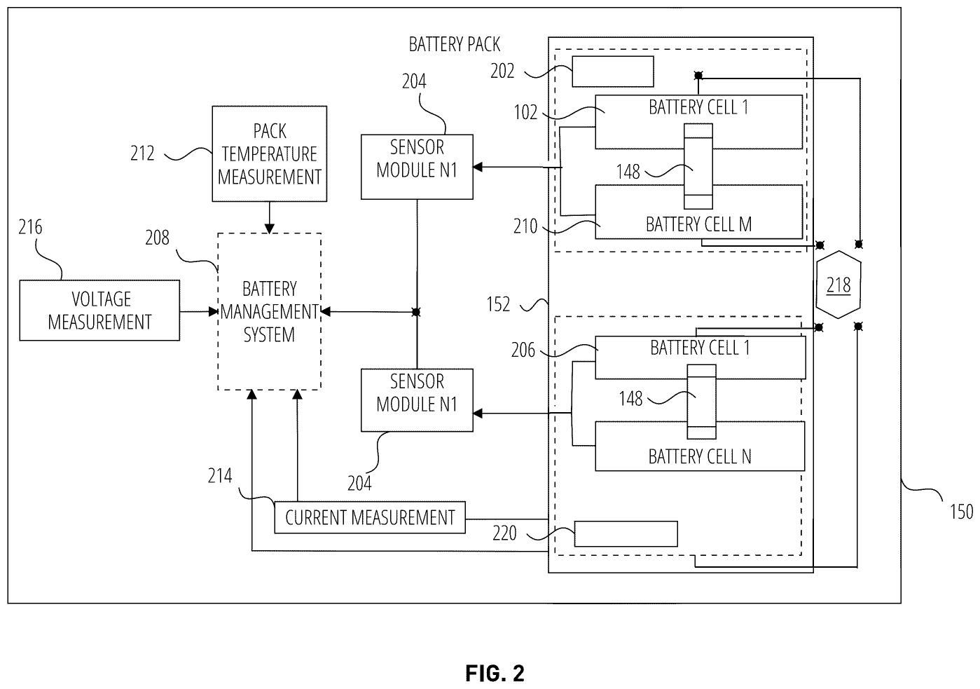

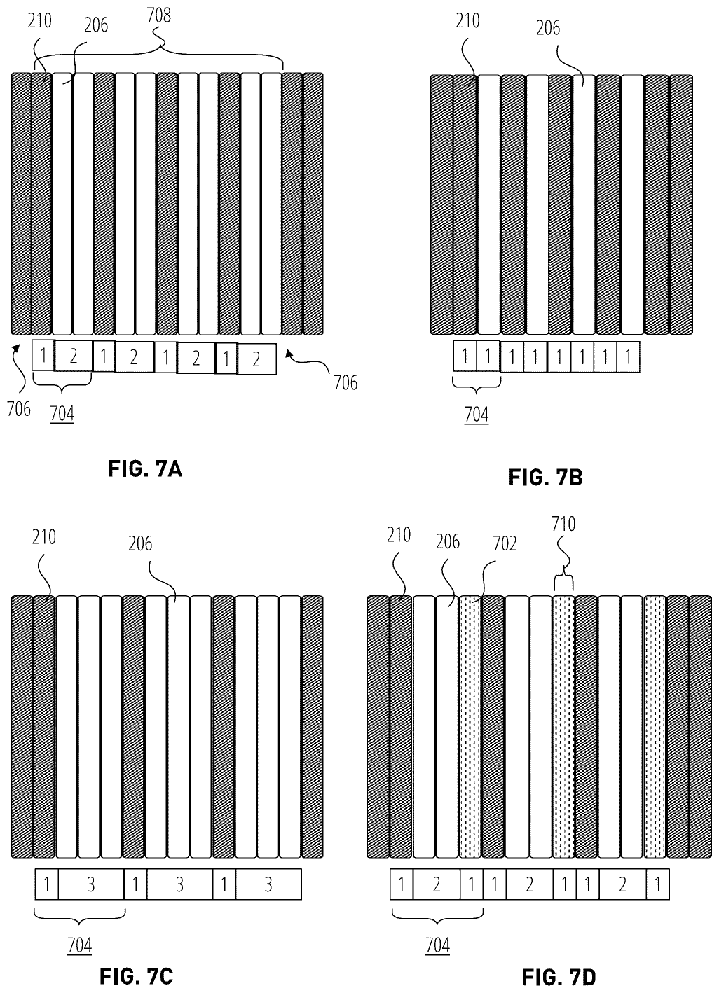

The battery pack 150 may be constructed from a variety of chemical formulations, including, for example, lead acid, nickel-metal hydride (NIMH), Lithium-Ion or anode free cells. FIG. 2 shows a schematic of the battery pack 150 in a simple configuration of cells 102 in modules 152. The plurality of first cells of FIG. 2 may be traction cells 210 which may be interleaved with the plurality of second cells which may be range extender cells 206 (See FIG. 7A-FIG. 7D for interleaving). A galvanically isolated bi-directional DC-DC converter 218 may be selectively utilized to bi-directionally transfer energy between the range extender cells 206 and the traction cells 210. The battery pack 150 may also have controllers such as the battery management system (BMS 208) that monitors and controls the performance of the battery pack 150. In some embodiments, the battery pack 150 may also comprise a traction pack energy manager 202 and a range extender energy manager 220. The traction pack energy manager 202 may monitor cell/module voltage and temperature, state of health, state of charge, and state of power. It may also perform cell balancing, and set high voltage cable/connector current limits, perform contactor control and isolation monitoring. The range extender energy manager 220 may aggregate DC-DC and range extender cell states, convert range extender power requests to DC-DC requests, compute in and our current and perform cell balancing procedures.

The BMS 208 may monitor several battery pack level characteristics such as current 214, voltage 216 and pack temperature 212. The BMS 208 may have non-volatile memory such that data may be retained when the BMS 208 is in an off condition. Retained data may be available upon the next key cycle.

In addition to monitoring the pack level characteristics, there may be cell 102 level characteristics that are measured and monitored, for example, through the traction pack energy manager 202. For example, the terminal voltage, current, and temperature of each cell 102 may be measured. A system may use a sensor module(s) 204 to measure the cell 102 characteristics. Depending on the capabilities, the sensor module(s) 204 may measure the characteristics of one or multiple of the cells 102. Each sensor module(s) 204 may transfer the measurements to the BMS 208 for further processing and coordination. The sensor module(s) 204 may transfer signals in analog or digital form to the BMS 208. In some embodiments, the sensor module(s) 204 functionality may be incorporated internally to the BMS 208. That is, the sensor module(s) 204 hardware may be integrated as part of the circuitry in the BMS 208 and the BMS 208 may handle the processing of raw signals.

It may be useful to calculate various characteristics of the battery pack. Quantities such a battery power capability and aggregated battery state of charge may be useful for controlling the operation of the battery pack as well as any electrical loads receiving power from the battery pack. Battery power capability is a measure of the maximum amount of power the battery can provide or the maximum amount of power that the battery can receive for the next specified time period, for example, 1 second or less than one second. Knowing the battery power capability allows electrical loads to be managed such that the power requested is within limits that the battery can handle.

Aggregated battery pack state of charge (SOC) may provide an indication of how much charge remains in the battery pack. The battery pack SOC may be output to inform the driver of how much charge remains in the battery pack, similar to a fuel gauge. The battery pack SOC may also be used to control the operation of an electric vehicle. Calculation of battery pack or cell SOC can be accomplished by a variety of methods. One possible method of calculating battery SOC is to perform an integration of the battery pack current over time. Calculation of battery pack or cell SOC can also be accomplished by using an observer, whereas a battery model is used for construction of the observer, with measurements of battery current, terminal voltage, and temperature. Battery model parameters may be identified through recursive estimation based on such measurements. The BMS 208 may estimate various battery parameters based on the sensor measurements.

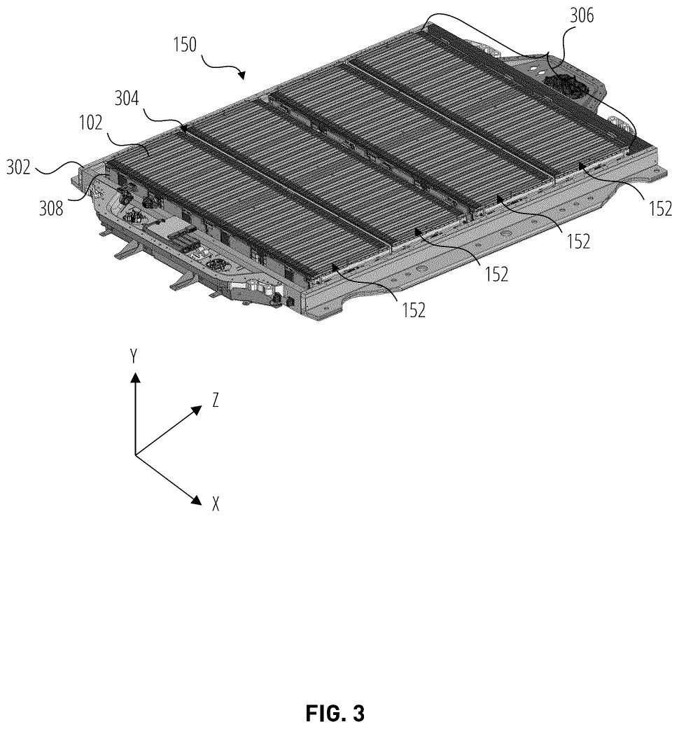

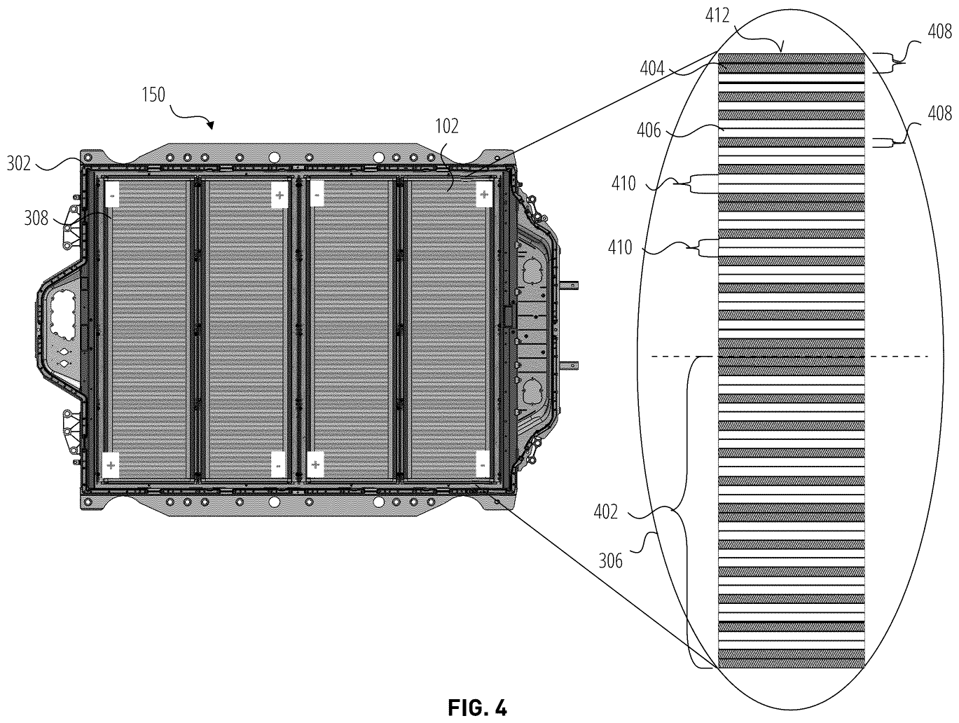

Turning to FIG. 3, a perspective view of a battery pack 150 in which illustrative embodiments may be implemented will now be described. A top view of the battery pack 150 of FIG. 3 is shown in FIG. 4. The battery pack 150, in one example embodiment, can form or be included in the battery pack 150 of FIG. 1 or FIG. 2. The battery pack 150 may include an enclosure 302 that may house one or more modules 152. In one aspect, a module 152 comprises a module housing 308 enclosing a cell array 306, a plurality of first cells 404 of the cell array 306 being disposed within the module housing 308 as one or more first groups 408 of electrically coupled cells, the plurality of first cells 404 comprising a first chemistry. A plurality of second cells 406 of the cell array 306 may be disposed within the module housing 308 as one or more second groups 410 of electrically coupled cells, the plurality of second cells 406 comprising a second chemistry different from the first chemistry. The cell array 306 may alternatively be disposed directly inside the battery pack. For illustration purposes, the plurality of first cells may be, for example, traction cells and the plurality of second cells may be, for example, range extender cells. The one or more second groups 410 of electrically coupled cells may be interleaved with the one or more first groups 408 of electrically coupled cells. The specific interleaving arrangement, other than the alternating characteristic/pattern of the first and second groups of cells, may be based on the pack requirements. For example, each group of the one or more first groups of electrically coupled cells or of the one or more second groups of electrically coupled cells comprise at most two cells per group or at most four cells per group. However, since traction cells typically have relatively higher onset temperatures, one or more traction cells may be disposed on the outside of each alternating pattern. More specifically, cells with higher onset temperatures for thermal runway may be safer and thus may be disposed on the outside of each alternating pattern. This may reduce the requirements for protection against intrusion during a crash. For illustrative purposes, traction cells used herein may be regarded as having higher onset temperatures for thermal runway than range extender cells used herein. However, it should be noted that this is not always the case as onset temperatures for thermal runway may depend on factors such as cell chemistry rather than whether a cell is a traction cell or a range extender cell. Thus, onset temperatures for thermal runway may be the cell characteristic to consider in the placement of cells. The one or more first groups 408 of electrically coupled cells may each comprise at least one cell and the one or more second groups 410 of electrically coupled cells each comprise at least one cell.

Further, the plurality of first cells 404 may be electrically isolated from the plurality of second cells 406 by the galvanically isolated bi-directional DC-DC converter 218. Responsive to an energy transfer request, energy may be transferred from the plurality of second cells to the plurality of first cells, or vice versa, through the galvanically isolated bi-directional DC-DC converter 218. In the example of FIG. 4, a module 152 may comprise two sub-modules 402 and thus the battery pack 150 may comprise 8 total sub-modules 402, with all sub-modules 402 being electrically identical.

Cells of the plurality of first cells 404 or of the plurality of second cells 406 may be arranged in series or in parallel or both and the arrangement may be based on the manner in which cell terminals are connected. For example, the plurality of first cells 404 may form a traction pack and may comprise traction modules or sub-modules that are electrically coupled in series with each other. The plurality of second cells 406 may also form a range-extender pack and may comprise range extender modules or sub-modules with each range extender module or sub-module coupled with a corresponding traction module in parallel, via the galvanically isolated bi-directional DC-DC converter 218, but not in series with each other. Thus, in this example, the traction modules or submodules may be in series but not the range-extender modules or sub-modules. Of course, this is not meant to be limiting as other architectures with other series/parallel arrangements may be obtained in light of the descriptions. In an illustrative embodiment, the plurality of first cells 404 are electrically coupled in series and the plurality of second cells 406 are also electrically coupled in series. Each of the plurality of cells may have a large wall surface and a small wall surface, i.e., a surface area of the small wall surface is less that a surface area of the large wall surface. In an illustrative embodiment, the cells may be prismatic cells. The cells may also have the same geometry. For example, the cells may have a total cell length of about 415 mm+/−20 mm, a total cell height of about 120 mm+/10 mm and a width of 17.9 mm+/5 mm. Of course, there are examples and are not meant to be limiting. For each cell array 306, the cells may be arranged such their large wall surfaces 412 are parallel to each other.

In an illustrative embodiment, electronics of the modules 152 may be disposed in a module cross channel 304 to save space and protect the electronics from external impact forces. The module cross channel 304 may serve as a pocket to house the galvanically isolated bi-directional DC-DC converter 218. By making the electronics long and flat, they may be packaged in a frame rail that houses the busbars, thus reducing wiring needs, increasing volumetric energy density and disposing the DC-DC converters away from crash intrusion zones. Further, the packaging structure may be configured to dissipate heat from the DC-DC components.

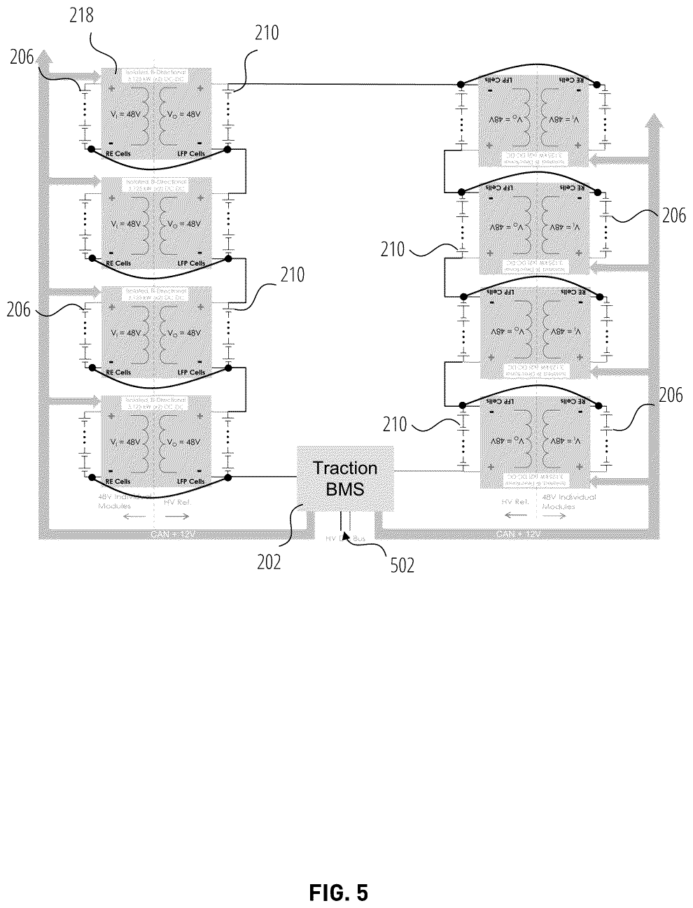

FIG. 5 shows a schematic diagram of an exemplary battery pack 150. In the battery pack of FIG. 5, the plurality of first cells 404 may be traction cells 210 and the plurality of second cells 406 may be range extender cells 206, though other chemistries and cell types having different onset temperatures for thermal runway may be possible in light of the descriptions. The set of traction cells 210 may be arranged in series to give the full pack voltage. The series connected traction cells 210 in each module may provide, for example, a total of 48 volts. Said series connected traction cells 210 may be connected to a set of range extender cells 206 in the module 152 via the galvanically isolated bi-directional DC-DC converter 218. For example, a first set (e.g., half) of the range extender cells 206 may be connected to a first set (e.g., half) of the series connected traction cells through a first galvanically isolated bi-directional DC-DC converter 218 and a second set (e.g., half) of the range extender cells 206 may be connected to a second set (e.g., half) of the series connected traction cells through a second galvanically isolated bi-directional DC-DC converter 218. Thus, the second galvanically isolated bi-directional DC-DC converter 218 may serve as a backup responsive to a failure event of the first galvanically isolated bi-directional DC-DC converter 218. The set of range extender cells may also provide 48 volts. The range extender cells 206 may be connected through their paired traction cells to the high voltage DC bus 502 and the traction cells 210 may be connected in series to the BMS or traction pack energy manager 202. In some cases, the range extender cells may also have their own BMS. By keeping the voltages in a module under 48V, the creepage and clearance requirements in the pack may be reduced, i.e., components can be disposed closer together without risking electrical arcing. Further, by staying under 60V, for example, lower cost gallium nitride components may be used thereby providing comparatively a higher power density. Further, the negative terminal or ground terminal of the range extender cell stack may be referenced to the paired traction cell stack. This may provide a fixed electrical ground reference, rather than leaving it a floating ground (which may be less deterministic in behavior) or referencing it to pack ground (which may not reduce the creep age requirements).

According to an illustrative embodiment wherein the plurality of first cells 404 are traction cells 210 and the plurality of second cells 406 are range extender cells 206, the traction cells may comprise lithium iron phosphate (LFP) cathode or oxide-based cathode such as a layered-oxide or spinal oxide and the range extender cell may be a lithium metal or anode-free cell. Anode-free, anode-less or initial anode-free cells, are a type of lithium metal cells. Lithium-metal cells may work in a similar fashion to lithium-ion cells but instead of using a graphite anode host material, may use a high-energy lithium metal. Anode-free lithium (Li) metal cells are lithium metal cells that may be manufactured without a lithium metal anode, or any other anode host material, such as graphite, titanate, iron-oxide, silicon, silicon-oxide. In some embodiments discussed herein, the anode-free cells may be cells wherein a lithium anode is subsequently generated, after manufacturing, in operando inside the cell during operation as the cell changes under an external influence when the cell is charged the first time. However, in other embodiments discussed herein, anode-free cells may be cells that have a ratio of anode capacity to cathode capacity being less than 1 when the cell in a fully charged state. In other words, all lithium may be removed from the cathode when the cell is fully charged. Lithium ions, provided by the cathode active material, are deposited as metallic lithium onto a metal substrate, such as copper or nickel foil or mesh to create the working cell. Though anode-free, anode-less or initial anode-free cells are discussed herein, these are not meant to be limiting as the methods and systems may also equally apply to lithium metal cells and other cells in general.

The range extender cells 206 and traction cells 210 are merely examples of cells for the plurality of second cells 406 and the plurality of first cells 404 respectively and are not meant to be limiting examples. Thus, more generally, the first chemistry (chemistry of the plurality of first cells 404) may be configured to have a higher onset temperature and/or a lower heat release for thermal runaway than that of the second chemistry (chemistry of the plurality of second cells 406). For example, LFP may have an onset of 250-300° C. and NMC (Lithium nickel manganese cobalt oxides) may have onset temperatures from 140-250° C. depending on the composition. An example low-onset temperature cell (relative to a higher-onset temperature cell) may be an NMC811 cathode with onset temperature for thermal runway of ˜160° C.

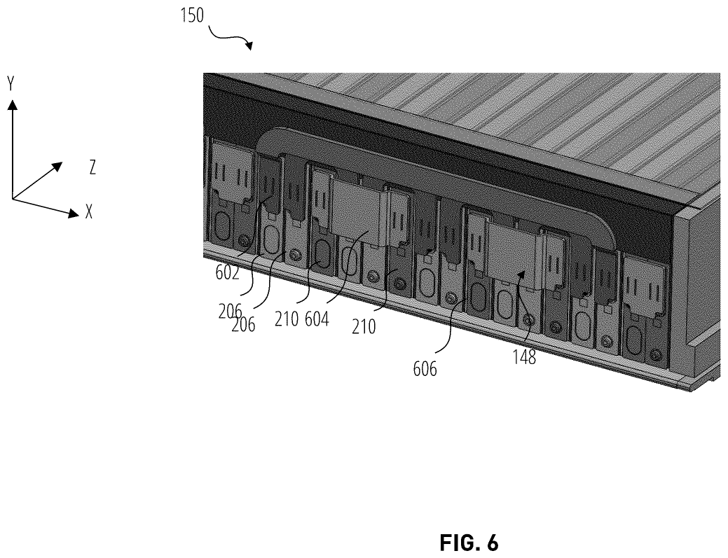

FIG. 6 depicts a perspective view of a battery pack having a busbar arrangement in a module according to illustrative embodiments. The battery pack may comprise one or more first busbars configured in this case as range extender busbars 602 to connect the one or more first groups 408 of electrically coupled cells together. One or more second busbars configured as traction busbars 604 may connect the one or more second groups 410 of electrically coupled cells together. The one or more first and/or second busbars may be offset from each other. For example, the one or more first and/or second busbars may be offset horizontally (in the Z-direction of FIG. 6). More specifically, the traction busbar 604 may have at least a middle portion thereof offset from both end portions to accommodate one or more range extender busbars 602 in the middle portion when assembled. The one or more first and/or second busbars may also be offset vertically (in the Y-direction as discussed hereinafter). The one or more first and/or second busbars may be adapted to dissipate heat, responsive to a thermal event of one cell, from said one cell to a non-adjacent other cell through thermal conduction. The battery pack may also further include a compliant thermal insulator disposed between adjacent cells of the cell array and configured to have a substantially low thermal conductivity at high temperatures of said thermal event, wherein the compliant thermal insulator suppresses heat transfer to adjacent cells based on said low thermal conductivity. A substantially low thermal conductivity may include, for example, 0.02 W/(m*K) at ambient temperature, 0.04 W/(m*k) at 600° C., 0.05-0.06 W/(m*K) at 800° C. Other ranges may include 20× the given conductivities such as 0.02-0.4 W/(m*K) at ambient temperature, 0.04-0.8 W/(m*k) at 600° C., 0.05-1 W/(m*K) at 800° C. When a cell goes into thermal runway, it may get significantly hot. This may heat up a neighboring cell above its maximum temperature and that cell then goes into thermal runway. This effect may propagate throughout the entire pack and may cause the electric vehicle to burn. By way of the “skipped cell” busbar arrangement and/or the compliant thermal insulator 606, if one cell goes into thermal runway, other cells may be prevented from also going into thermal runway. The insulator may at least be disposed in each traction-range extender interface. In an example wherein a module only has range-extender cells and no traction cells, a cell going into thermal runway may heat up to, for example, about 300° C., or 400-480° C. or 1200° C. or even higher). About half of the heat may flow into connected busbars and about the other half may be dissipated through other locations. The nearest range extender cell may then heat up to about, for example, 245° C. which may be above a light-off temperature of 160° C. This may result in propagation of thermal runway in the pack or module. However, in an interleaving architecture wherein the module comprises a cells of different chemistries interleaved together, because the busbars skip over from one set of range extenders to another set of range extenders that is not immediately adjacent thereto and because the through-face heating (heating through the large wall surfaces 412) may propagate from a range extender to a traction cell, the heat may be spread out to a larger number of cells and a temperature of the nearest traction cells may increase to a value (e.g. 135 degree Celsius) which may be below its light off temperature. Of course, these values are not non-limiting as other values may be obtained based on cell design and composition. Moreover, the cells may also be connected to a cold plate 802 to further dissipate heat. Further, when operating the traction cells at high power under normal operation, the architecture may also help dissipate heat to the range extender cells without reaching temperatures that may degrade performance. Other technical features may be readily apparent to one skilled in the art in view of the illustrative embodiments.

FIG. 7A-FIG. 7D depict examples repeating patterns 704 that illustrate the interleaving of one or more first groups of electrically coupled cells with one or more second groups of electrically coupled cells. For illustration purposes, the one or more first groups of electrically coupled cells may be traction cells 210 and the one or more second groups of electrically coupled cells may be range extender cells 206, though this is not meant to be limiting. In the specific example of FIG. 7A, a traction cell 210 may be disposed adjacent to two range extender cells to form a “1:2” pattern of traction and range-extender cells. This “1:2” pattern may repeat throughout the module 152 or sub-module 402 to form an internal portion 708 of the module 152 or sub-module 402 and one or more traction cells 210 may be placed at the ends 706 of the internal portion 708.

FIG. 7B shows a “1:1” repeating pattern 704 of traction cells and range extender cells and FIG. 7C shows a “1:3” repeating pattern of traction and range extender cells. As shown in FIG. 7D, a module or sub-module may also further include a plurality of one or more other types of cells 702 disposed as one or more other groups of electrically coupled cells within the module housing, wherein the plurality of first cells (traction cells in the case of FIG. 7D), the plurality of second cells (range extender cells in the case of FIG. 7D) and the plurality of one or more other types of cells 702 are interleaved to form another repeating pattern of cells. As illustrated in FIG. 7D, the pattern is a “1:2:1” pattern of traction, range extender and one other type of cell 702 with at least one traction cell disposed at the ends of the internal portion 708. Of course, other patterns and types of cells may be possible in view of the descriptions herein. For example, a string of each cell in a module may be connected in series to another string of cells in another module and then the entire series connection of multiple strings may be linked to each other through a DC-DC converter.

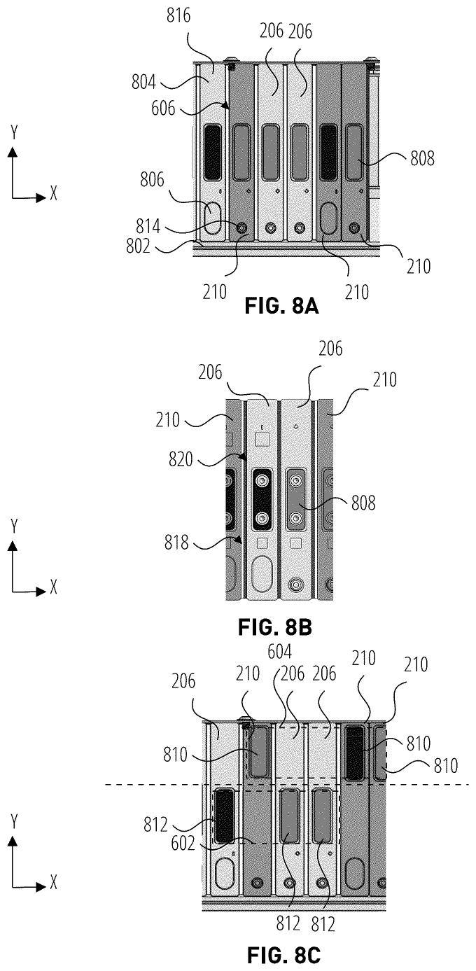

In most cases, cell types having the highest volatilities (lowest onset temperatures for thermal runway) may be protected in the internal portions 708 and module/sub-module as a whole by designing patterns that sandwich said cell types using other cell types with lower volatilities (highest onset temperatures for thermal runway) and/or by placing said other cell types with lower volatilities at the ends 706. Each type of cell may have its own busbar connection that employs the skipped cell architecture described herein to enhance heat dissipation. Insulators and cold plates 802 may further be utilized to enhance heat dissipation as shown in FIG. 8A-FIG. 8C.

FIG. 8A-FIG. 8C illustrate a front view of modules disposed in a battery pack and showing corresponding cell terminals 808. As shown in FIG. 8A, a module may comprise a compliant thermal insulator 606 disposed between adjacent cells, a cell vent 806, a terminal 808, and an electrolyte fill opening 814. The module may be disposed in the battery pack on a cold plate 802 that may be configured to conduct heat away from a cell. In some cells, the cell vent 806 may be located on a first front surface 816 of the cell that is parallel to the X-Y plane. In other cells, the position of the cell vent 806 may be on a second back surface of the cell that is opposite the first front surface 816. In a module architecture, these two kinds of cells may be interleaved to provide an even or substantially even dissipation of heat from the cell vents disposed in a battery pack. The electrolyte fill opening 814 may be used to introduce electrolyte into a cell. Each cell may have a terminal 808 comprising a positive and a negative terminal. In the case of FIG. 8A a compliant thermal insulator 606 may be disposed between each two adjacent cells.

As depicted in FIG. 8B, a pressure differential across electrodes may be improved by use of a thermal insulator 818 and a separate compliant pad 820 disposed between some cells. For example, the thermal insulator 818 and separate compliant pa may be disposed between a traction cell 210 and an adjacent range extender cell 206 and a compliant pad may be disposed between two adjacent range extender cells 206.

Furthermore, the position of the terminals of the traction cells 210 may be offset, for example vertically, in the Y-direction, from the position of the terminals of the range extender cells 206 as shown in FIG. 8C. More specifically, traction terminals 810 (and thus, corresponding traction busbar 604) may be offset from range extender terminal 812 (and thus, corresponding range extender busbar 602) in the Y direction of FIG. 8C. This may enable cells of one chemistry or type to be easily electrically coupled by respective busbars without having to offset the busbars in the Z-direction unlike what is shown in FIG. 6. This may lead to simpler busbar designs and the saving of space.

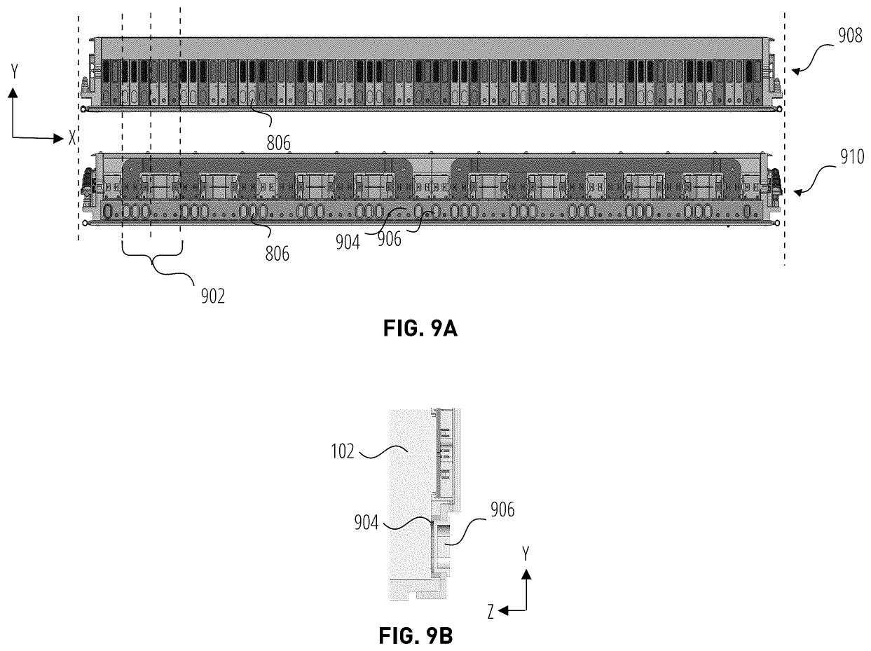

A front view of a module without a manifold (view without a manifold 908) and with a manifold (view with a manifold 910) are depicted in FIG. 9A. A cross-sectional view of a cell thereof is shown in FIG. 9B. The manifold may comprise a gasket 904 and plugs 906 for the cell vents 806 and may be positioned adjacent to the cell vents 806 to receive hot gases and dissipate said hot gases throughout pipes of the manifold. The cell vents 806 may be arranged in an alternating fashion 902 and the openings of the manifold may be positioned adjacent to cell vents and may vent all cell runaway ejecta into the correct channel, and conduct it out of the module without leaking internally. Further, a cell on fire may pop out its plug 906 and vent to the channel while other cells in the module may their vents covered so that vent gases do not light them off also.

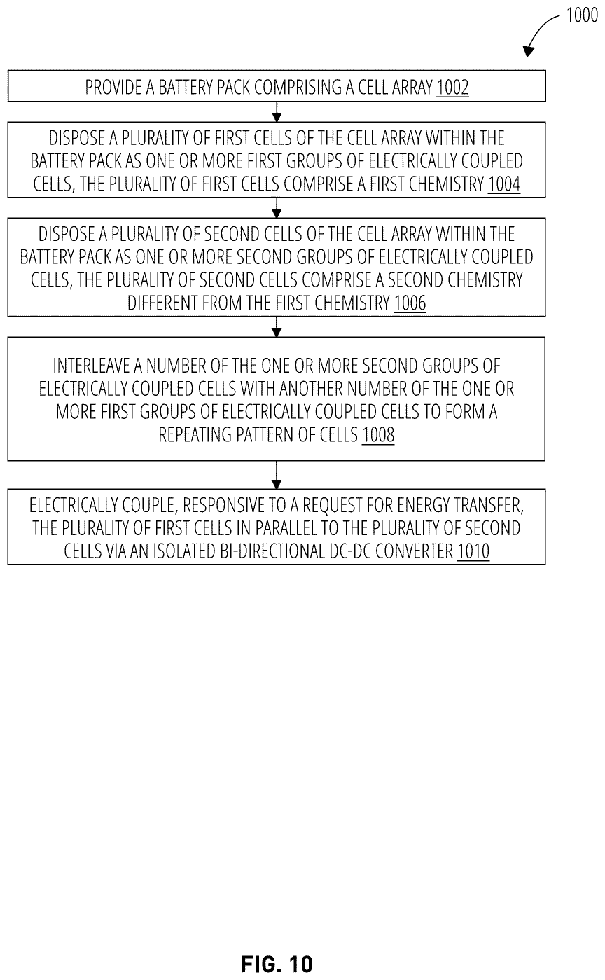

FIG. 10 shows a method of producing a battery pack according to one or more embodiments. The method may begin at step 1002, wherein the method 1000 may provide a battery pack comprising a cell array. In step 1004, method 1000 may dispose a plurality of first cells of the cell array within the module housing as one or more first groups of electrically coupled cells, the plurality of first cells comprising a first chemistry. In step 1006, method 1000 may dispose a plurality of second cells of the cell array within the module housing as one or more second groups of electrically coupled cells, the plurality of second cells comprising a second chemistry different from the first chemistry. The plurality of first cells may have a higher onset temperature and/or a lower heat release for thermal runaway relative to that of the plurality of second cells. In step 1008, method 1000 may interleave a number of the one or more second groups of electrically coupled cells with another number of the one or more first groups of electrically coupled cells to form a repeating pattern of cells. In step 1010, method 1000 may electrically couple, responsive to a request for energy transfer, the plurality of first cells in parallel to the plurality of second cells via a galvanically isolated bi-directional DC-DC converter. At least one cell with the first chemistry having said higher onset temperature and/or a lower heat release may be disposed at each end of the repeating pattern of cells.

Of course, the method may not be limited to two types of cells, or two types of chemistries having different onset temperatures for thermal runway as additional types of cells or chemistries may be incorporated without departing from the objectives described herein.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

Thus, the various embodiments described above have been presented by way of example and not limitation. It will be apparent to persons skilled in the relevant art(s) that various changes in form and detail can be made therein without departing from the spirit and scope of the present invention. Thus, the present invention should not be limited by any of the above-described exemplary embodiments but should be defined only in accordance with the following claims and their equivalents.

In addition, it should be understood that the attached drawings, which highlight functionality described herein, are presented as illustrative examples. The architecture of the present invention is sufficiently flexible and configurable, such that it can be utilized and navigated in ways other than that shown in the drawings.

Further, the purpose of the Abstract is to enable the U.S. Patent and Trademark Office and the public generally, and especially scientists, engineers, and practitioners in the relevant art(s), who are not familiar with patent or legal terms and/or phraseology, to determine quickly from a cursory inspection the nature and essence of the technical subject matter disclosed herein. The Abstract is not intended to be limiting as to the scope of the present invention in any way. It is also to be understood that the procedures recited in the claims need not be performed in the order presented.

What is claimed is:

1. A battery pack comprising:
a cell array;
a plurality of first cells of the cell array disposed within the battery pack as one or more first groups of electrically coupled cells, the plurality of first cells comprising a first chemistry; and
a plurality of second cells of the cell array disposed within the battery pack as one or more second groups of electrically coupled cells, the plurality of second cells comprising a second chemistry, a number of the one or more second groups of electrically coupled cells being interleaved with another number of the one or more first groups of electrically coupled cells to form a repeating pattern of cells;
wherein the plurality of first cells has a different performance profile and/or different physical dimensions than the plurality of second cells;
wherein the plurality of first cells is electrically coupled in parallel to the plurality of second cells.

2. The battery pack of claim 1, wherein the second chemistry is different from the first chemistry.

3. The battery pack of claim 1, wherein the plurality of first cells is electrically coupled in parallel to the plurality of second cells via a DC-DC converter.

4. The battery pack of claim 1, wherein the performance profile comprises one or more selected from a group consisting of: onset temperature; heat release for thermal runaway; energy density; and resistance.

5. The battery pack of claim 1, further comprising:
one or more first busbars configured to connect the one or more first groups of electrically coupled cells together;
one or more second busbars configured to connect the one or more second groups of electrically coupled cells together;
wherein the one or more first and/or second busbars are adapted to dissipate heat, responsive to a thermal event of one cell, from said one cell to a non-adjacent other cell through thermal conduction.

6. The battery pack of claim 5, wherein, during the thermal event of the one cell, at least 10% of heat generated by the one cell is transferred to the non-adjacent other cell.

7. The battery pack of claim 5, wherein locations of terminals of the one or more first busbars are offset from locations of terminals of the one or more second busbars.

8. The battery pack of claim 1, wherein the plurality of second cells is configured to transfer energy to the plurality of first cells.

9. The battery pack of claim 4, wherein at least one cell with the first chemistry having said higher onset temperature and/or a lower heat release is disposed at each end of the repeating pattern of cells.

10. The battery pack of claim 1,
wherein the one or more first groups of electrically coupled cells are connected in series;
wherein an output of the series connected one or more first groups of electrically coupled cells is connected to a battery management system.

11. The battery pack of claim 1, wherein the one or more second groups of electrically coupled cells are connected in series;
wherein an output of the series connected one or more second groups of electrically coupled cells is connected to a battery management system.

12. The battery pack of claim 1, further comprising:
a thermal insulator disposed between adjacent cells of the cell array and configured to have a substantially low thermal conductivity at high temperatures of said thermal event;
wherein the thermal insulator is adapted to suppress heat transfer, responsive to a thermal event of one cell, from said one cell to an adjacent other cell based on said low thermal conductivity.

13. The battery pack of claim 1, wherein the plurality of first cells is a plurality of traction cells having said higher onset temperature and/or lower heat release and the plurality of second cells is a plurality of range-extender cells having a comparatively lower onset temperature and/or higher heat release.

14. The battery pack of claim 1, wherein the plurality of first cells comprises a lithium iron phosphate cathode or oxide based cathode.

15. The battery pack of claim 1, wherein the plurality of second cells are anode-free cells.

16. The battery pack of claim 1, further comprising:
a plurality of one or more other type of cells of the cell array disposed as one or more other groups of electrically coupled cells within the battery pack;
wherein the plurality of first cells, the plurality of second cells and the plurality of one or more other type of cells are interleaved to form another repeating pattern of cells, and
and wherein at least one cell having said higher onset temperature and/or a lower heat release for thermal runaway is disposed at each end of the another repeating pattern of cells.

17. The battery pack of claim 1, wherein each group of the one or more first groups of electrically coupled cells or of the one or more second groups of electrically coupled cells comprise at most four cells per group.

18. The battery pack of claim 1, wherein the plurality of first cells and the plurality of second cells have a same geometry.

18. The battery pack of claim 1, further comprising:
a manifold comprising a plurality of openings each positioned adjacent to a cell vent.

19. The battery pack of claim 1, further comprising:
a battery module comprising a module housing that houses the cell array, wherein the module comprises a plurality of other cell arrays.

20. The battery pack of claim 1, further comprising:
a plurality of other battery modules.
